(19) United States
(12) Patent Application Publication
(10) Pub. No.: US 2024/0373302 A1
(43) Pub. Date: Nov. 7, 2024

(54) UNDISTURBED PERFORMANCE FROM SERVICE HANDOVER THRESHOLDS

(71) Applicant: T-Mobile Innovations LLC, Overland Park, KS (US)

(72) Inventors: Raymond E. REEVES, Orlando, FL (US); John Paxton SMITH, Wolfforth, TX (US)

(21) Appl. No.: 18/310,624

(22) Filed: May 2, 2023

(51) Int. Cl. H04W 36/00; H04W 24/08

(52) U.S. Cl. CPC H04W 36/00837; H04W 24/08

(57) ABSTRACT

Systems, methods and devices are provided for facilitating undisturbed performance during service handover thresholds. Methods include monitoring performance parameters over time for multiple types of wireless devices experiencing a handover triggering event and storing the performance parameters for the multiple types of wireless devices. The methods further include analyzing the stored performance parameters for the multiple types of wireless devices to formulate a handover plan for the multiple types of wireless devices. The method further includes generating the handover plan for the multiple types of wireless devices and utilizing the handover plan to determine whether handover default settings should be utilized or overridden.

### TECHNICAL BACKGROUND

A wireless network, such as a cellular network, can include an access node (e.g., base station) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)). Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. For example, 5G networks provide edge deployments enabling computing capabilities closer to UEs. However, increased interference and latencies may be created due to higher power capabilities of 5G devices.

With respect to voice calling technologies, voice over LTE (VoLTE) has become prevalent in both 4G networks and hybrid networks utilizing 4G and 5G RATs. VoLTE is an LTE high-speed wireless communication standard for mobile phones and data terminals, including Internet of things (IoT) devices and wearables. VoLTE has several times more voice and data capacity than older technologies. Further, it uses less bandwidth than previous technologies.

Voice over new radio (VoNR) has evolved as a 5G high-speed wireless communication standard for mobile phones and data terminals, including Internet of things (IoT) devices and wearables. VoNR fully utilizes the 5G Standalone (SA) core and can have better voice quality than its predecessor VoLTE. An advantage of VoNR over VoLTE is faster call setup time due to the inherent lower latency of 5G NR. However, due to the prevalence and extensive use and development of VoLTE, challenges exist in developing VoNR to provide a customer experience that equals or surpasses that provided by VoLTE.

With current efforts underway to increase the infrastructure for the 5G standalone architecture, efforts to improve the VoNR customer experience have become more critical. Typically, to ensure sufficient quality of service, network operators aim to trigger handovers based on a signal quality differential between a source access node and a target access node. Engineering efforts currently accelerate this handover for UEs engaged in VoNR in order to allow a handover from fading cell coverage into expectedly better cell coverage as the UE moves away from the fading cell coverage. However, these efforts have resulted in unexpected customer VoNR service impacts due to excessive handovers, as the natural movement of individuals is unpredictable.

Accordingly, improvements are provided herein that overcome such deficiencies by leveraging learned behaviors and impacts to make optimized handover determinations for UEs utilizing specific services, such as VoNR.

### OVERVIEW

Exemplary embodiments described herein include systems, methods, and processing nodes for optimizing the wireless device experience, particularly during VoNR. A method includes monitoring performance parameters and route information over time for multiple types of wireless devices experiencing a handover triggering event. The method further includes storing the performance parameters and the route information for the multiple types of wireless devices. Additionally, the method includes analyzing the stored performance parameters and the route information for the multiple types of wireless devices to formulate a handover plan for the multiple types of wireless devices and generating the handover plan for the multiple types of wireless devices.

An additional exemplary method includes receiving, at a modular intelligence controller, a route information report from a wireless device experiencing a handover triggering event based on a stored handover threshold. The method further includes determining, at the modular intelligence manager, based on the route information report and stored intelligence, whether to override or approve a handover.

An additional exemplary embodiment includes modular intelligence controller having a memory storing instructions and a processor executing the stored instructions to perform multiple operations. The operations include monitoring performance parameters over time for multiple types of wireless devices experiencing a handover triggering event and storing the performance parameters for the multiple types of wireless devices. The operations additionally include analyzing the stored performance parameters for the multiple types of wireless devices to formulate a handover plan for the multiple types of wireless devices and generating the handover plan for the multiple types of wireless devices.

### BRIEF DESCRIPTION OF THE DRAWINGS

FIG. 1 depicts an exemplary operating environment system for employing a modular intelligence controller in accordance with the disclosed embodiments.

FIG. 2 illustrates an additional exemplary operating environment for a modular intelligence controller in accordance with disclosed embodiments.

FIG. 3 illustrates an exemplary configuration for a modular intelligence controller in accordance with disclosed embodiments.

FIG. 4 depicts an exemplary access node in accordance with disclosed embodiments.

FIG. 5 depicts an exemplary wireless device in accordance with the disclosed embodiments.

FIG. 6 depicts an exemplary method for facilitating undisturbed performance from service handover thresholds in accordance with disclosed embodiments.

FIG. 7 depicts an exemplary method for facilitating undisturbed

performance from service handover thresholds in accordance with disclosed embodiments.

FIG. 8 depicts a further exemplary method for facilitating undisturbed performance from service handover thresholds in accordance with disclosed embodiments.

### DETAILED DESCRIPTION

Exemplary embodiments described herein include systems, methods, and devices for optimizing wireless device experience, particularly during VoNR. A method includes monitoring performance parameters and route information over time for multiple types of wireless devices experiencing a handover triggering event. The method further includes storing the performance parameters and the route information for the multiple types of wireless devices. Additionally, the method includes analyzing the stored performance parameters and the route information for the multiple types of wireless devices to formulate a handover plan for the multiple types of wireless devices and generating the handover plan for the multiple types of wireless devices.

Currently, as VoNR deployment capitalizes on spectrum, efforts are underway to convert to an all 5G standalone architecture, In conjunction with this deployment, it is desirable to develop technology that ensures the customer experience resulting from the VoNR service is at or above current service levels in traditional voice calls and Voice over 4G LTE (VoLTE). Current efforts provide differentiated network handoff levels not only based on the RAN network technology but also dependent on the current service that any particular subscriber wireless device or user equipment (UE) is consuming. Namely, while methods exist to instruct a UE to handoff as soon as the signal quality differential between a source node and a target node reaches a threshold, methods have further been to initiate a UE handoff to another cell sooner when the UE is engaged in a particular service, e.g. VoNR.

While this procedure allows the UE to handoff into an expectedly better coverage as it is moving away from a fading cell coverage, unexpected customer VoNR service impacts have occurred, resulting in an interruption of VoNR service. Because the natural movement of individuals is unpredictable and at times can result in ping-ponging or constant handovers, gaps in VoNR service have occurred.

Considering these drawbacks, systems, methods, and devices are proposed to enhance existing network processes and components now configured to have service-specific handover thresholds to support an advanced undisturbed performance from service handover threshold (UPSHOT) architecture whereby existing handover processes triggered through static on-size-fits-all thresholds are automatically and systematically informed to allow for a flexible handover policy based on current and historical network behaviors and customer perceived performance. In essence, UPSHOT-aware UEs and access nodes are assisted by an UPSHOT modular intelligence controller responsible for distributed, top-level aggregation and distribution of expected performance tailored to each user while relying on similar experience of others and its immediate forecast.

Embodiments disclosed herein leverage learned behaviors and performance parameters of specific UEs in order to predict future behaviors and performance. For example, embodiments disclosed herein build UE profiles and generate handover plans corresponding to specific UE profiles. The developed handover plans can be utilized to override default handover thresholds when learned behaviors illustrate better performance than can be achieved through the use of default settings.

In embodiments described herein, processing tasks may be performed at a core network or closer to the cellular customer in order to reduce network congestion and increase processing speed. For example, the UPSHOT technology may be implemented the cellular base stations or other edge nodes in order to enable flexible and rapid deployment for improved service. Further, in addition to the modular intelligence controller, UEs and access nodes are equipped with intelligent features that interact with the modular intelligence controller.

Through the use of systems, methods, and devices described herein, existing handover processes triggered through static on-size-fits-all thresholds are automatically and systematically evaluated to allow for a flexible handover based on current and historical network behaviors and customer perceived performance.

In addition to the systems and methods described herein, the operations for facilitating undisturbed performance from service handover thresholds may be implemented as computer-readable instructions or methods, and processing nodes on the network for executing the instructions or methods. The processing node may include a processor included in the access node or a processor included in any controller node in the wireless network that is coupled to the access node.

Thus, the expectation is that the UPSHOT architecture may allow improved 5G VoNR network performance and an improved customer service experience with increased availability and reliability by way of ensuring a handover strategy that is customized to immediate needs informed by historical trends for specific subscribers and network-wide observations.

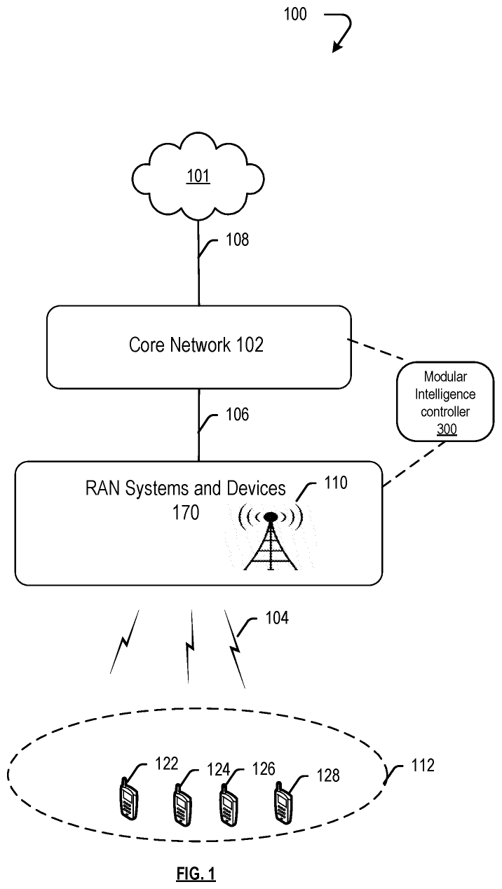

FIG. 1 depicts an exemplary system 100 for wireless communication, in accordance with the disclosed embodiments. The system 100 may include a communication network 101, core network 102, and a radio access network (RAN) 170 including at least one access node 110. The RAN 170 may include other devices and additional access nodes. The system 100 also includes multiple wireless devices 122, 124, 126, and 128, which may be end-user wireless devices and may operate within one or more coverage areas 112 and communicate with the RAN 110 over communication links 104, which may for example be 5G NR communication links. Communication links 104 may additionally include, for example, 4G LTE communication links, or any other suitable type of communication link.

The system 100 may further include a modular intelligence controller 300, which is illustrated as operating between the core network 102 and the RAN 170. However, it should be noted that the modular intelligence controller 300 may be distributed. For example, the modular intelligence controller 300 may utilize components located at both the core network 102, at multiple access nodes 110 and at the wireless devices 122, 124, 126, 128. Alternatively, the modular intelligence controller 300 may be an entirely discrete component operating between the core network 102 and the RAN 170.

The modular intelligence controller 300 receives information pertaining to wireless device type, wireless device travel path, wireless device speed, wireless device location, and wireless device performance parameters. The wireless devices 122, 124, 126, and 128 further may send a type including a make and model and indicate a current service being utilized, e.g., VoNR to the modular intelligence controller 300.

The modular intelligence controller 300 analyzes this information for many wireless devices over time to develop a handover plan for each wireless device. The handover plan may involve either accepting or overriding existing handover rules and default handover thresholds.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 122, 124, 126, 128. Wireless network protocols can comprise MBMS, code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

The core network 102 includes core network functions and elements. The core network may have an evolved packet core (EPC) structure or may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QOS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120, 130, 140 and is responsible for handling connection and mobility management tasks. The SMF is primarily responsible for creating updating and removing sessions and managing session context. The UDM function provides services to other core functions, such as the AMF, SMF, and NEF. The UDM function may function as a stateful message store, holding information in local memory. The NSSF can be used by the AMF to assist with the selection of network slice instances that will serve a particular device. Further, the NEF provides a mechanism for securely exposing services and features of the core network.

Communication links 106 and 108 can use various communication media, such as air, space, metal, optical fiber, or some other signal propagation path—including combinations thereof. Communication links 106 and 108 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Other wireless protocols can also be used. Communication links 106 and 108 can be direct links or might include various equipment, intermediate components, systems, and networks, such as a cell site router, etc. Communication links 106 and 108 may comprise many different signals sharing the same link. Communication links 106 and 108 may be associated with many different reference points, such as N1-Nxx, as well as S1-S.xx, etc.

The RAN 170 may include various access network systems and devices such as access node 110. The RAN 170 is disposed between the core network 102 and the end-user wireless devices 122, 124, 126, 128. Components of the RAN 170 may communicate directly with the core network 102 and others may communicate directly with the end user wireless devices 122, 124, 126, 128. The RAN 170 may provide services from the core network 102 to the end-user wireless devices 122, 124, 126, and 128.

The RAN 170 includes at least an access node (or base station) 110, such as an eNodeB, a next generation NodeB (gNodeB) 110 communicating with the plurality of end-user wireless devices 122, 124, 126, 128. It is understood that the disclosed technology for may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB.

Access nodes 110 can be, for example, standard access nodes such as a macro-cell access node, a base transceiver station, a radio base station, an eNodeB device, an enhanced eNodeB device, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access nodes 110 may comprise a short range, low power, small-cell access node such as a microcell access node, a picocell access node, a femtocell access node, or a home eNodeB device. As will be further described below, functionality for tagging requests from wireless devices may be included within the access nodes. Access nodes 110 can be configured to deploy one or more different carriers, utilizing one or more RATs. For example, a gNodeB may support NR and an eNodeB may provide LTE coverage. Any other combination of access nodes and carriers deployed therefrom may be evident to those having ordinary skill in the art in light of this disclosure.

The access nodes 110 can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Furthermore, in embodiments set forth herein, the access nodes 110 store default handover thresholds and existing handover rules. Further, in embodiments set forth herein, the access nodes 110 are able to interact with the modular intelligence controller 300 to accept or override existing rules and default handover thresholds.

The wireless devices 122, 124, 126, and 128 may include any wireless device included in a wireless network. For example, the term “wireless device” may include a relay node, which may communicate with an access node. The term “wireless device” may also include an end-user wireless device, which may communicate with the access node in the access network 110 through the relay node. The term “wireless device” may further include an end-user wireless device that communicates with the access node directly without being relayed by a relay node. In embodiments disclosed herein, the wireless devices 122, 124, 126, and 128 may be equipped with particular processing components to report relevant information to the modular intelligence controller 300, such as device location, device route, device speed, device type, and performance parameters. Further, the wireless devices may be equipped with logic to respond to instructions generated by the modular intelligence controller 300.

Wireless devices 122, 124, 126, and 128 may be any device, system, combination of devices, or other such communication platform capable of communicating wirelessly with access network 110 using one or more frequency bands and wireless carriers deployed therefrom. Each of wireless devices 122, 124, 126, and 128, may be, for example, a mobile phone, a wireless phone, a wireless modem, a personal digital assistant (PDA), a voice over internet protocol (VOIP) phone, a voice over packet (VOP) phone, or a soft phone, as well as other types of devices or systems that can send and receive audio or data. The wireless devices 122, 124, 126 128 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless devices 122, 124, 126, and 128. Wireless network protocols may include one or more of Multimedia Broadcast Multicast Services (MBMS), code division multiple access (CDMA) 1xRTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), and Fifth Generation mobile networks or wireless systems (5G, 5G New Radio (“5G NR”), or 5G LTE). Wired network protocols utilized by communication network 101 may include one or more of Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the access network 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication system 100 may be, comprise, or include computers systems and/or processing nodes, including access nodes, controller nodes, and gateway nodes described herein.

The operations for facilitating undisturbed performance from service handover thresholds may be implemented as computer-readable instructions or methods, and processing nodes on the network for executing the instructions or methods. The processing node may include a processor included in the access node or a processor included in any controller node in the wireless network that is coupled to the access node.

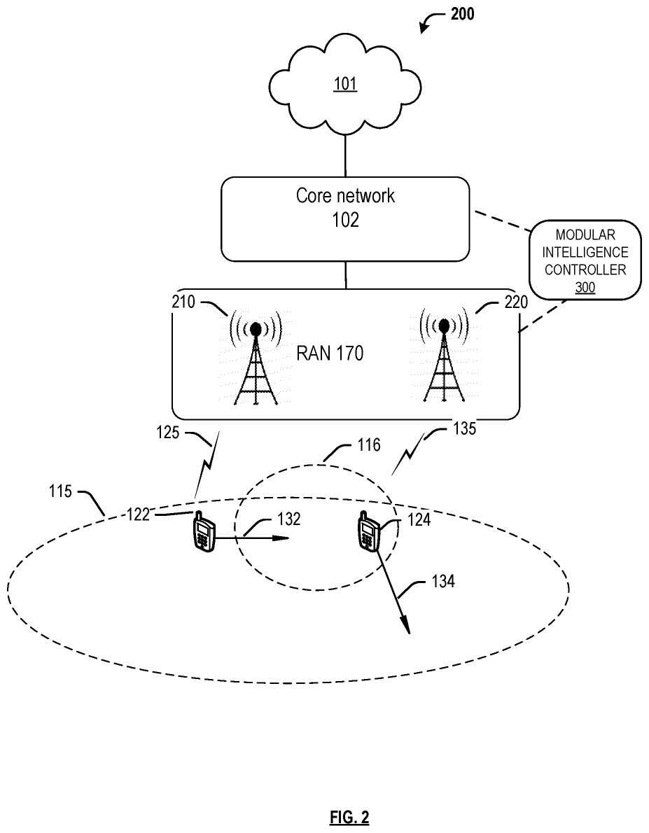

FIG. 2 depicts an exemplary system 200 for wireless communication, in accordance with the disclosed embodiments. The system 200 may include a communication network 101, core network 102, a radio access network (RAN) 170 including access nodes 210 and 220 and multiple wireless devices 122, 124 able to communicate within the network. The wireless devices 122, 124 may be end-user wireless devices and may operate within one or more coverage areas 115 and 116 communicate with the RAN 170 over communication links 125, 135 which may for example be 5G NR communication links or any other suitable type of communication link.

While like reference numbers may refer to the elements described above with respect to FIG. 1, the system 200 may include more than one access node such as access nodes 210 and 220. Further, these access nodes 210 and 220 may have two different coverage areas 215 and 216. As illustrated, the access node 210 may serve at least one wireless device 122 in coverage area 215. UE 124 may be located in coverage area 216 and may be served by the access node 220 over communication link 135. Any number of wireless devices 124 may be served by the access node 220.

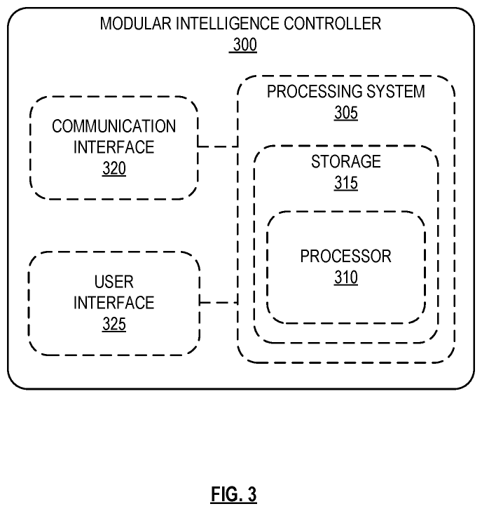

The wireless device 122 may take route 132 and the wireless device 124 may take route 134. The routes 132 and 134 may be associated with specific map coordinates as well as a velocity. Thus, the route may be expressed based on a current location and a velocity vector including a magnitude and direction. The modular intelligence controller 300 may be a separate component that communicates with the access nodes 210 and 220 and may also communicate with the core network 102. The modular intelligence controller 300 may be substantially as described herein with respect to FIG. 3 and may control whether the wireless devices 122 and 124 operate in accordance with stored policies, for example, a default handover threshold stored at the access node, or whether the stored policies should be overridden for the wireless device 122 and 124. For example, the modular intelligence controller 300 may override the handover policy for the wireless device 122 and accept the handover policy for the wireless device 124. The modular intelligence controller 300 may determine whether the wireless devices are utilizing a specific service, for example, VoNR. If the wireless devices are not using a specific identified service, the modular intelligence controller 300 may allow standard or default handover thresholds stored at the access nodes 122, 124, to take effect. However, if the wireless devices 122 and 124 are engaged in a specific service, such as, for example, VoNR, the modular intelligence controller may analyze the path of the wireless device 122, 124 to determine whether to utilize the stored default handover thresholds. While the coverage for wireless device 122 may momentarily be better from access node 220 than from access node 210, the path 132 of the wireless device 122 shows that the wireless device 122 will only briefly be in coverage area 116. With respect to wireless device 124, the path 134 of the wireless device 124 shows that it is likely to permanently exit the coverage area 134 and thus a handover of the wireless device 124 from the access node 220 to the access node 210 in accordance with a default threshold will be approved.

The wireless devices 122 and 124 may, for example, be UPSHOT capable UEs that seek input from the modular intelligence controller 300 as they approach a different coverage area. Further, the access nodes 210 and 220 may be UPSHOT-aware access nodes relying on past instructions from the modular intelligence controller 300. As a further option, the access nodes 210 and 220 may send an inquiry to the modular intelligence controller 300 to determine the best handover decision for the UE in question. This interaction with the modular intelligence controller 300 may be repeated many times over the network across all possible paths and UEs engaged in a variety of services (including, but not limited to VoNR) to eventually build enough intelligence for the modular intelligence controller 300 to instruct UPSHOT-aware access nodes 210, 220 on modified instructions, e.g. have the access node 210, 220 preserve the coverage for particular UEs at certain conditions instead of demanding early handover based on pre-existing rules related to default settings.

For instance, architecture disclosed herein avoids triggering a handover based on default settings if the handover is going to be short-lived. This can be determined based on the velocity vector of the wireless device 122, 124, a current location of the wireless device 122, 124, and an analysis of the coverage areas 215, 216. In such cases, an UPSHOT-capable UE would seek input from a modular intelligence controller 300 by reporting its “flight” path so that the modular intelligence controller 300 may approve the handover or override the handover. Alternatively, an UPSHOT-aware access node, such as node 210 or 220 may rely on past modular intelligence controller instructions or on demand send an inquiry to the modular intelligence controller 300 to determine the best handover decision for the subject UE. The process aims to build enough intelligence for the modular intelligence controller 300 to instruct UPSHOT-aware access nodes 210, 220 with modified instructions. For example, the modular intelligence controller 300 may instruct the access node 210, 220 to preserve the coverage for particular UEs 122, 124 at certain conditions instead of demanding early handover based on pre-existing rules and default thresholds.

FIG. 3 depicts an exemplary modular intelligence controller 300, which may be configured to perform the methods and operations disclosed herein to provide undisturbed performance during service handover thresholds. In the disclosed embodiments, the modular intelligence controller 300 may be integrated with the access node 210, 220, the core network 102, or may be an entirely separate component capable of communicating with the access nodes 210, 220, core network 102, and or the wireless devices 122, 124.

The modular intelligence controller 300 may be configured for determining whether to accept or override handover instructions stored at the access nodes 210, 220 based on different conditions, locations, and times. To derive a handover plan, the modular intelligence controller 300 may include a processing system 305. Processing system 305 may include a processor 310 and a storage device 315. Storage device 315 may include a disk drive, a flash drive, a memory, or other storage device configured to store data and/or computer readable instructions or codes (e.g., software). The computer executable instructions or codes may be accessed and executed by processor 310 to perform various methods disclosed herein. Software stored in storage device 315 may include computer programs, firmware, or other form of machine-readable instructions, including an operating system, utilities, drivers, network interfaces, applications, or other type of software. For example, software stored in storage device 315 may include a module for performing various operations described herein. For example, instructions may be provided to monitor and analyze wireless device performance, location, and movement over time to formulate a handover plan for each wireless device type. Further, the storage device 315 may store intelligence including the formulated handover plan for wireless device, which may include, for example, a handover map illustrating optimal handover locations based on existing coverage areas and the parameters reported by each wireless device 122, 124. Processor 310 may be a microprocessor and may include hardware circuitry and/or embedded codes configured to retrieve and execute software stored in storage device 315.

The modular intelligence controller 300 may include a communication interface 320 and a user interface 325. Communication interface 320 may be configured to enable the processing system 305 to communicate with other components, nodes, or devices in the wireless network. For example, the modular intelligence controller 300 can share intelligence including the stored handover plans with UPSHOT aware access nodes 210, 220.

Communication interface 320 may include hardware components, such as network communication ports, devices, routers, wires, antenna, transceivers, etc. User interface 325 may be configured to allow a user to provide input to the modular intelligence controller 300 and receive data or information from the modular intelligence controller 300. User interface 325 may include hardware components, such as touch screens, buttons, displays, speakers, etc. The modular intelligence controller 300 may further include other components such as a power management unit, a control interface unit, etc.

The modular intelligence controller 300 thus may utilize the memory 315 and the processor 310 to perform multiple operations. For example, the processor 310 may access stored instructions in the memory 310 to determine if the wireless device is using a particular service, determine route information of the wireless device, consult stored intelligence matching with the wireless device and the route information and accept or override stored handover instructions based on the consultation.

Thus, the modular intelligence controller 300 may analyze the path information over time as well as performance parameters associated with the path information in order to help build the intelligence to optimize the user experience for the particular service. The intelligence may include, for example, a handover map stored in conjunction with a UE profile. For example, each type of UE may have its own handover map based on the UE profile and the intelligence building process. Alternatively, a consolidated handover plan and handover map may be built for multiple types of UEs. The modular intelligence controller 300 may utilize the stored intelligence to determine whether to accept or override stored handover threshold.

Furthermore, modular intelligence controller 300 may utilize artificial intelligence (AI) to automatically collect intelligence and characterize the intelligence in accordance with historical patterns. For example, the processor 310 of the modular intelligence controller 300 may train and implement a model incorporating performance measurements over time correlated with a particular type of wireless device and the wireless device path.to facilitate automatic determination of whether a handover for a particular service should occur according to default parameters or whether the modular intelligence controller 300 should provide an instruction to override the default parameters and the handover should be delayed.

The location of the modular intelligence controller 300 may depend upon the network architecture. For example, in smaller networks, a single modular intelligence controller 300 may be disposed for communication with UPSHOT aware UEs and UPSHOT aware RANs. However, in a larger network, multiple modular intelligence controllers 300 may be required to cover the network. Further, the functions of the modular intelligence controller 300 may be split between the core network 102 and the Ran 170.

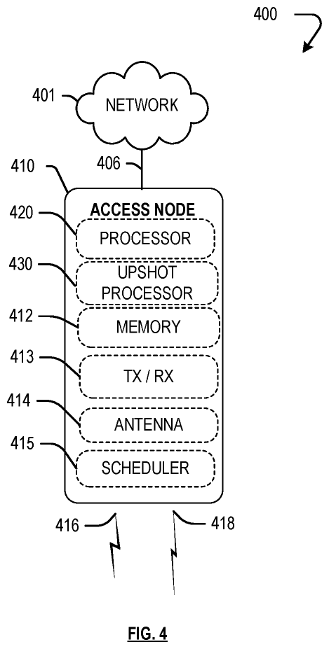

FIG. 4 illustrates an operating environment 400 for an exemplary access node 410 in accordance with the disclosed embodiments. In exemplary embodiments, the access node 410 is an UPSHOT-aware access node in that it is able to interact effectively with the modular intelligence controller 300 to facilitate undisturbed performance during service handover thresholds. The access node 410 can include, for example, a gNodeB or an eNodeB. In specific embodiments provided herein, in which the service is VoNR, the access node 410 is a gNB. Access node 410 may comprise, for example, a macro-cell access node, such as access node 110 described with reference to FIG. 1. Access node 410 is illustrated as comprising a processor 420, an UPSHOT processor 430, a memory 412, transceiver(s) 413, and antenna(s) 414. Processor 420 executes instructions stored on memory 412, while transceiver(s) 413 and antenna(s) 414 enable wireless communication with other network nodes, such as wireless devices and other nodes. For example, wireless devices may initiate uplink transmissions such that the transceivers 413 and antennas 414 receive messages including, for example, route information and performance parameters from the wireless devices, for example, over communication links 416 and 418. The transceivers 413 and antennas 414 may further pass the messages to a mobility entity in the core network. Further, the transceivers 413 and antennas 414 receive signals from the mobility entity such as a mobility management entity (MME) or access and mobility function (AMF) and pass the messages to the appropriate wireless device. Scheduler 415 may be provided for scheduling resources based on the presence and performance parameters of the wireless devices as well as based on policies transmitted from the core network. Network 401 may be similar to the network 101 discussed above with respect to FIG. 1.

In embodiments provided herein, processor 420 may operate in conjunction with scheduler 415 and UPSHOT processor 430 to optimize handover scheduling based on historical patterns. In operation, the UPSHOT processor 430 may be integrated with the processor 420 or alternatively may comprise logic stored in the memory 412 to execute UPSHOT procedures. For example, the UPSHOT processor 430 may receive instructions from the modular intelligence controller 300 and may provide the received instructions to the wireless devices 122, 124. The UPSHOT processor 430 may further provide stored default handover thresholds to the modular intelligence controller 300.

While the processor 420, the UPSHOT processor 430, and the scheduler 415 are shown as separate components, these components may optionally be integrated in various combinations. For example, the processor 420 may perform the functions described above with respect to the UPSHOT processor 430 by accessing stored instructions from the memory 412. Further, the memory 412 may store service specific information, such as VoNR quality of service (QOS) requirements, timers for connectivity, and thresholds for handing over. The stored thresholds may, for example, be default thresholds for the particular service. The QoS for VoNR may require, for example, that VoNR be provided without service gaps or interruptions.

The access node 410 may utilize transceivers 413 and antennas 414 to communicate information, for example with the wireless devices 122, 124, and with the core network 102. For example, these components may receive requests from the wireless devices 122, 124 and further may receive instructions, such as policies, from the core network 102 and the modular intelligence controller 300. For example, the access node 410 may report network events, outages, or overloading to the modular intelligence controller 310. Such events could change the decisions being made at the modular intelligence controller 300. For example, if an access node 410 is overloaded, the modular intelligence controller 300, upon receiving this notification, may not allow handovers to the access node 410.

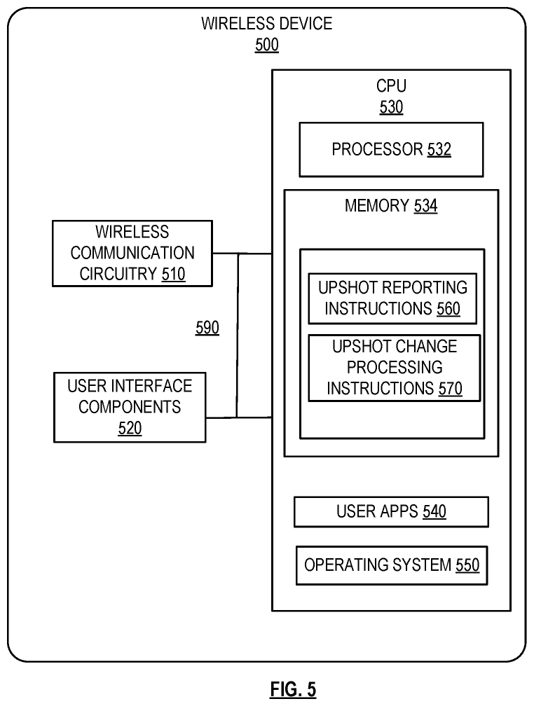

FIG. 5 depicts a wireless device (UE) 500 in accordance with disclosed embodiments. The wireless device 500 may correspond to one of wireless devices 122, 124 in FIG. 1 or 2. As illustrated, the wireless device 500 includes wireless communication circuitry 510, user interface components 520, a central processing unit (CPU) 530, processor 522, memory 534, user apps 540, and operating system 550. Components may be connected, for example, by a bus 590. These components are merely exemplary and the wireless device 500 may include a larger or smaller number of components capable of performing the functions described herein. Wireless devices such as smartphones may have multiple microprocessors and microcontrollers. A microprocessor may have a bus to communicate with memory on separate chips and buses to communicate with the rest of the equipment. Alternatively or additionally, the mobile phone may include a System On a Chip (SoC).

The memory 534 may store, for example, UPSHOT reporting instructions 560 and UPSHOT change processing instructions 570. When executed by the processor 532, the programming shown interacts with the modular intelligence controller 300 to assist with the methods described herein.

The UPSHOT reporting instructions 560 may cause the wireless device 500 to report its performance parameters, travel path, and other information to the modular intelligence controller 300. For example, the wireless device 500 may report a velocity vector indicating magnitude and direction. Further the wireless device reporting instructions may cause the wireless device 500 to report signal to noise and interference ratio (SINR), reference signal received power (RSRP), reference signal received quality (RSRQ), or other signal strength indicators. Additionally, the wireless device 500 may report its location to the modular intelligence controller 300. Additionally, the wireless device 500 may report its make and model (e.g., iPhone® or Android® 8, 10, 14, etc.) as well as the service it is currently using, e.g., VoNR. Further, the UPSHOT change processing instructions 570 may cause the wireless device 500 to process a handover in accordance with instructions formulated by the modular intelligence controller 300 and received from the access node 400.

The wireless communication circuitry 510 may include circuit elements configured to generate wireless signals (e.g., one or more antennas) as well as interface elements configured, for example, to translate control signals from the CPU 530 into data signals for wireless output. Further, the wireless communication circuitry 510 may include multiple elements, for example to communicate in different modes with different RATs. The CPU 530 may be configured to receive, interpret, and/or respond to signals received via the wireless communication circuitry 510. The CPU 530 may be configured to receive a network command (e.g., from an access node 410 or from the modular intelligence controller 300) to perform other specified functions. The user interface components 520 may be or include any components enabling a user to interact with the wireless device 500,

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication systems 100 or 200 may be, comprise, or include computers systems and/or processing nodes, including access nodes, controller nodes, and gateway nodes described herein.

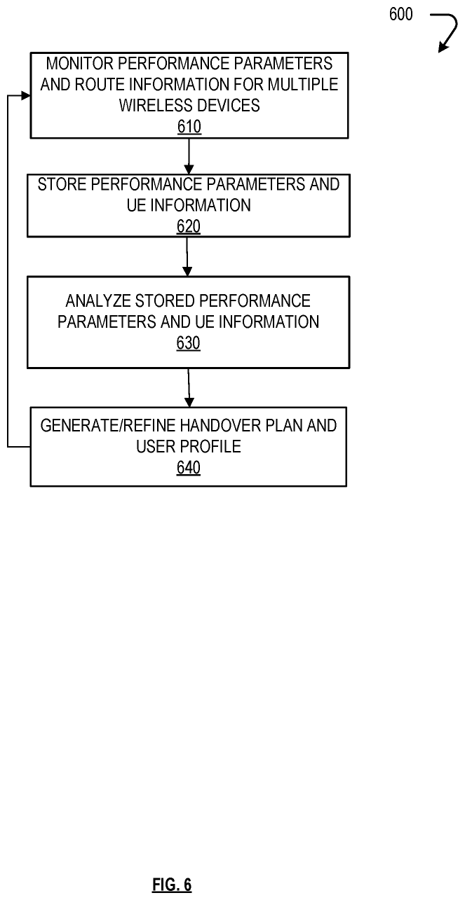

The disclosed methods for providing undisturbed performance during service handover thresholds are discussed further below. FIG. 6 illustrates an exemplary method 600 for achieving undisturbed performance from service handover thresholds by building stored intelligence based on historical patterns. Method 600 may be performed by any suitable processor discussed herein, for example, a processor 310 included in the modular intelligence controller 300. For discussion purposes, as an example, method 600 is described as being performed by the processor 310 of the modular intelligence controller 300.

Method 600 begins in step 610, when the modular intelligence controller 300 monitors performance parameters and route information for multiple wireless device. For example, the wireless devices 122, 124 send route information and performance parameters to the modular intelligence controller 300. The route information comprises, for example, a location and a velocity vector, and the performance parameters may include one or more of SINR, RSRP, and RSRQ. In larger networks, multiple modular intelligence controllers 300 may operate in multiple locations. The wireless devices 122, 124 further may send a type including a make and model and indicate a current service being utilized, e.g., VoNR.

In step 620, the modular intelligence controller 300 stores the performance parameters and route information for the multiple wireless devices. For example, the modular intelligence controller 300 may build UE profiles, so that each type of UE has an associated profile based on the performance parameters and route information.

Further, in step 630, the modular intelligence controller 300 analyzes the stored performance parameters and route info in order generate a handover plan in step 640. By continuously monitoring, storing, and analyzing in steps 610, 620, and 630, the modular intelligence controller is able to build and refine a handover plan in step 640. Thus, the modular intelligence controller 300 builds network, subscriber and UE intelligence as well as historical trends. The handover plan may include a handover map illustrating locations where default settings should be accepted and locations where default settings should be followed for each particular type of wireless device.

In embodiments set forth herein, the modular intelligence controller 300 further informs UPSHOT-aware RAN nodes and UEs regarding new directives or handover plans dictating when to override stored or default handover triggers, thereby forcing an UPSHOT-aware UE to stay in the same coverage in order to avoid the negative experience of multiple handovers and service interruption. The modular intelligence controller 300 may inform the UEs and access nodes proactively or based on their inquiries.

Additionally, it should be noted that the handover plan is created for a particular service, which in examples provided herein is VoNR. Multiple handover plans may be formulated for multiple different services and further multiple handover plans may be formulated for multiple different types of wireless devices, such as for example different modules of iPhone® and Android® devices.

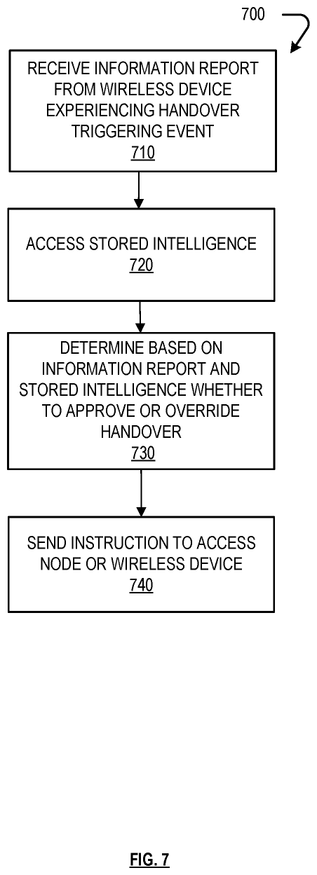

FIG. 7 illustrates further details of facilitating undisturbed performance during service handover thresholds. In particular, FIG. 7 illustrates a response by the modular intelligence controller 300 or an UPSHOT aware access node when a UE 122, 124 experiences a handover triggering event. Method 700 may be performed by any suitable processor discussed herein, for example, a processor 310 included in the modular intelligence controller 300 of the UPSHOT processor 430 of the access node 410. For discussion purposes, as an example, method 700 is described as being performed by the modular intelligence controller processor 310.

In step 710, the modular intelligence controller 300 receives an information report from a wireless device experiencing a handover trigger event based on stored intelligence. For example, the information report may include a location, performance parameters, and a trajectory, such as a velocity vector. The wireless devices 122, 124 further may send a type including a make and model and indicate a current service being utilized, e.g., VoNR.

In step 720, the processor 310 of the modular intelligence controller 300 accesses the stored intelligence described above. For example, the processor 310 may access the stored handover plan for the particular UE in step 720. The processor 310 may further access a subscriber and UE profile.

In step 730, the processor 310 of the modular intelligence controller 300 determines based on the information report and the stored intelligence, such as the handover plan and UE profile, whether to override the handover dictated by default settings or whether to approve the handover. Thus, when UEs are on a rapid path through a small coverage area, the handover may be short-lived, and therefore the processor 310 of the modular intelligence controller 300 may detect that the handover based on default settings would be unsustainable and would lead to disturbed performance. Therefore, the processor 310 may override the handover in order to facilitate undisturbed performance. However, if upon checking the UE profile, the handover yields positive results, for example, if for most iPhone 14s, the performance is positive in the same situation, the handover is allowed.

Further, in step 740, the modular intelligence controller 300 sends the appropriate instruction to the UPSHOT aware access node 210, 220 or directly to the wireless device 122, 124. The particular configuration for conveying the instruction may depend on the location of the modular intelligence controller 300 within the network. For example, modular intelligence controllers 300 could be located both at the core network 102 and closer to a network edge so that inquiries may be processed locally, but decision making occurs at the core network 102.

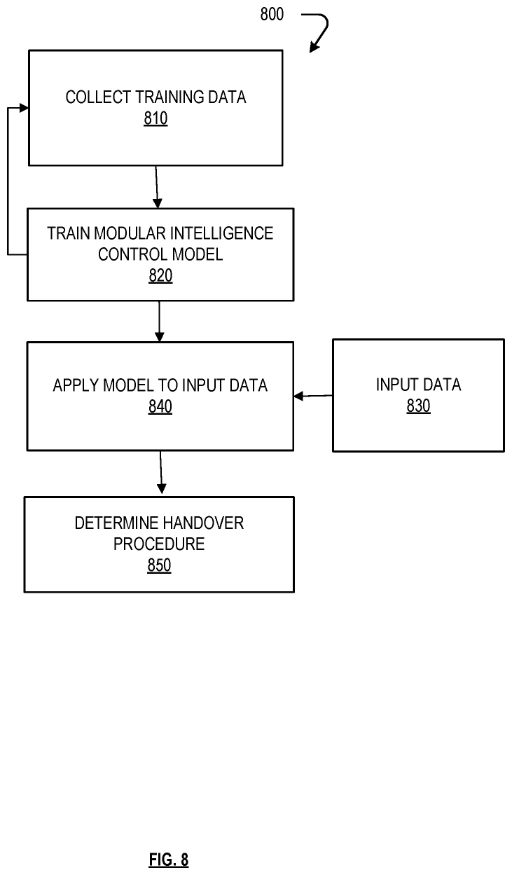

As illustrated in FIGS. 6 and 7, methods may be implemented to detect patterns and make handover decisions based on those patterns. Accordingly, embodiments set forth herein may utilize artificial intelligence (AI) methods to assign periodicity. FIG. 8 illustrates a method 800 for optimizing handover determination using AI techniques. The method 800 may be performed by any suitable processor such as, for example, the processor 310 of the modular intelligence controller 300. For the sake of illustration, the method 800 is described as being performed by the modular intelligence controller 300.

In step 810, the modular intelligence controller 300 collects training data. For example, step 810 may implement the method shown in FIG. 6 to collect training data and to train the modular intelligence control model in step 820. The modular intelligence control model may correlate at least wireless device paths and wireless device profiles to show the effects of handing over in accordance with pre-set thresholds for particular wireless devices following particular paths. Further, the UE profiles may contribute to a trained model for each type of wireless device, so that multiple trained models are accessible through the modular intelligence controller 300.

In step 830 data is input to the modular intelligence controller 300, for example, in the manner described above with respect to FIG. 7. The modular intelligence controller 300 applies the model to the input data in step 840. For example, the input data may be a wireless device model, one or more wireless device paths including both speed and direction, and one or more wireless device performance parameters. Based on the input data, the modular intelligence controller 300 is able to optimize performance for the wireless device by making a handover decision that allows for uninterrupted service in step 850.

In some embodiments, methods 600, 700, and 800 may include additional steps or operations. Furthermore, the methods may include steps shown in each of the other methods. As one of ordinary skill in the art would understand, the methods 600, 700, and 800 may be integrated in any useful manner and the steps may be performed in any useful sequence.

In some embodiments, methods 600, 700, and 800 may include additional or fewer steps or operations. Furthermore, the methods may include steps shown in each of the other methods. As one of ordinary skill in the art would understand, the methods 600, 700, and 800 may be integrated in any useful manner. Further, the order of the steps shown is merely exemplary and the order of steps may be rearranged in any useful manner.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
monitoring performance parameters over time for multiple types of wireless devices experiencing a handover triggering event;
storing the performance parameters for the multiple types of wireless devices;
analyzing the stored performance parameters for the multiple types of wireless devices to formulate a handover plan for the multiple types of wireless devices; and
generating the handover plan for the multiple types of wireless devices.

2. The method of claim 1, further comprising monitoring performance parameters during 5G voice over new radio (VoNR).

3. The method of claim 1, further comprising receiving route information from the wireless devices and monitoring the performance parameters for a route identified by the route information.

4. The method of claim 3, wherein the route information comprises a speed of the wireless device and a direction of the wireless device.

5. The method of claim 1, wherein the handover triggering event is based on a signal quality threshold.

6. The method of claim 1, further comprising formulating handover instructions based on the handover plan.

7. The method of claim 6, further comprising forwarding the handover instructions to an access node.

8. The method of claim 1, further comprising forwarding the handover instructions to the wireless device.

9. A method comprising:
receiving, at a modular intelligence manager, a route information report from a wireless device experiencing a handover triggering event based on a stored handover threshold; and
determining, at the modular intelligence manager, based on the route information report and stored intelligence, whether to override or approve a handover.

10. The method of claim 9, wherein the stored intelligence comprises a handover plan created by monitoring performance parameters and received route information reports.

11. The method of claim 10, wherein the route information report comprises a travel path and speed of the wireless device.

12. The method of claim 10, further comprising overriding the handover and sending a message to the wireless device overriding the handover.

13. The method of claim 10, further comprising updating the handover plan based on performance parameters and the route information reports and forwarding the updated handover plan to an access node.

14. The method of claim 9, further comprising accessing a wireless device profile.

15. The method of claim 9, further comprising receiving the route information report from a wireless device using 5G VoNR.

16. A modular intelligence manager comprising:
a memory storing instructions; and
a processor executing the stored instructions to perform operations including:
monitoring performance parameters over time for multiple types of wireless devices experiencing a handover triggering event;
storing the performance parameters for the multiple types of wireless devices;
analyzing the stored performance parameters for the multiple types of wireless devices to formulate a handover plan for the multiple types of wireless devices; and
generating the handover plan for the multiple types of wireless devices.

17. The modular intelligence manager of claim 16, the operations further comprising utilizing the handover plan to approve a handover based on a default threshold.

18. The modular intelligence manager of claim 16, the operations further comprising utilizing the handover plan to override a handover based on a default threshold.

19. The modular intelligence manager of claim 16, the operations further comprising transmitting the handover plan to an access node serving the wireless device.

20. The modular intelligence manager of claim 16, the operations further comprising monitoring performance parameters for wireless devices utilizing 5G VoNR.
